(19) United States
(12) Patent Application Publication
(10) Pub. No.: US 2023/0313079 A1
(43) Pub. Date: Oct. 5, 2023

(54) SURFACE TREATMENT LIQUID AND HYDROPHILIZATION TREATMENT METHOD

(71) Applicant: TOKYO OHKA KOGYO CO., LTD., Kanagawa (JP)

(72) Inventor: Takahiro SENZAKI, Kanagawa (JP)

(21) Appl. No.: 17/787,744

(22) PCT Filed: Nov. 26, 2020
(86) PCT No.: PCT/JP2020/043995

§ 371 Date: Jun. 21, 2022

(30) Foreign Application Priority Data
Dec. 24, 2019 (JP) 2019-233474

(51) Int. Cl. C11D 7/32; C11D 7/50; C11D 11/00

(52) U.S. Cl. CPC C11D 7/3209; C11D 7/50; C11D 11/0023; C11D 11/0064

(57) ABSTRACT

Provided are: a surface treatment liquid having a hydrophilization effect that is not easily deteriorated over time even if a surface-treated article is exposed to various agents; and a surface treatment method using the surface treatment liquid. The surface treatment liquid contains a resin (A) and a solvent (S). The resin (A) contains a constituent unit (a1) derived from a betaine monomer comprising a group having an ethylenically unsaturated double bond, a cationic group, and an anionic group, and not comprising an ester bond or an amide bond. The cationic group is preferably a quaternary nitrogen cation group, and the anionic group is preferably a sulfonic acid anion group, a phosphonic acid anion group, or a carboxylic acid anion group.

### TECHNICAL FIELD

The present invention relates to a surface treatment liquid and a hydrophilization treatment method using the surface treatment liquid.

### BACKGROUND ART

Conventionally, in order to modify the properties of surfaces of various articles, various surface treatment liquids are used to perform surface treatment. In surface modification, there is a great demand for hydrophilization of surfaces of articles, and thus a large number of agents and surface treatment liquids for hydrophilization have been proposed. By subjecting a target to surface treatment using an agent for hydrophilization and a surface treatment liquid, a coating is formed on a surface of the target, and the surface of the target is made to be hydrophilic.

For such agents and surface treatment liquids for hydrophilization, for example, a hydrophilization treatment agent containing a copolymer using at least an acrylamide monomer and a mono(meth)acrylate monomer as a component for expressing hydrophilic property (Patent Document 1), and hydrophilization treatment agents including a block copolymer of a polyvinyl alcohol resin block having a mercapto group and a polyanion resin block obtained by polymerizing a polymerizable monomer having at least one carboxy group and/or sulfonic acid group in a molecule, and polyacrylic acid, have been proposed (Patent Document 2).

Patent Document 1: Japanese Patent No. 5437523
Patent Document 2: Japanese Unexamined Patent Application, Publication No. 2009-126948

### DISCLOSURE OF THE INVENTION

### Problems to be Solved by the Invention

Targets of surface treatment, for example, windows and mirrors, may be exposed to cleaning agents or other chemicals used in cleaning. In particular, windows and mirrors used around water are often exposed to acidic cleaning agents used to remove water stains and basic cleaning agents used to remove mold. Furthermore, regardless of pH of cleaning agents, various cleaning agents, including soaps, shampoos, and the like, also include various ionic surface-active agents such as sodium fatty acids, sodium dodecyl sulfate (SDS), sodium linear alkyl ether sulfonate, and the like. Furthermore, the cleaning agents may include an organic acid or an organic base, for example, oleic acid, behenic acid, dimethylstearylamine, or dimethylcoconut amine, capable of forming anions or cations having a hydrophobic moiety.

However, there is a problem that when articles surface-treated with conventional hydrophilizing agents described in Patent Document 1 and 2 are exposed to cleaning agents containing acid, alkali, various ionic surface-active agents, an organic acid or an organic base capable of forming an anion or a cation having a hydrophobic moiety, the hydrophilicity of the surface-treated surfaces of articles may be gradually deteriorated over time.

The present invention has been made in view of the problems described above, and has an object to provide a surface treatment liquid having a hydrophilization effect that is not easily deteriorated over time even if a surface-treated article is exposed to various agents, and a surface treatment method using the surface treatment liquid.

### Means for Solving the Problems

The present inventors have found that the above-mentioned problems can be solved by a surface treatment liquid including a resin (A) and a solvent (S), the resin (A) including a constituent unit (a1) derived from a betaine monomer including a group having an ethylenically unsaturated double bond, a cationic group, and an anionic group, and not including an ester bond or an amide bond, and thereby have completed the present invention. More specifically, the present invention provides the following.

A first aspect of the present invention is a surface treatment liquid including a resin (A) and a solvent (S), the resin (A) including a constituent unit (a1) derived from a betaine monomer including a group having an ethylenically unsaturated double bond, a cationic group, and an anionic group, and not including an ester bond or an amide bond.

A second aspect of the present invention is a hydrophilization treatment method for making a surface of a treatment target hydrophilic, the method including applying the surface treatment liquid according to the first aspect to form a coating on the surface of the treatment target.

### Effects of the Invention

The present invention can provide a surface treatment liquid having a hydrophilization effect that is not easily deteriorated over time even if a surface-treated article is exposed to various agents, and a surface treatment method using the surface treatment liquid.

### PREFERRED MODE FOR CARRYING OUT THE INVENTION

### Surface Treatment Liquid

A surface treatment liquid includes a resin (A) and a solvent (S). Such a surface treatment liquid can hydrophilize a surface of a treatment target as an object to be surface-treated. Hereinafter, arbitrary components, essential components and the like, of the surface treatment liquid will be described.

### [Resin (A) ]

A resin (A) includes a constituent unit (a1) derived from a betaine monomer including a group having an ethylenically unsaturated double bond, a cationic group, and an anionic group, and not including an ester bond or an amide bond. The resin (A) may include a constituent unit other than the constituent unit (a1) as long as the object of the present invention is not inhibited.

### (Constituent Unit (a1))

In order to provide hydrophilicity to a surface of a treatment target by the surface treatment, the resin (A) includes a constituent unit (a1) derived from a betaine monomer including a group having an ethylenically unsaturated double bond, a cationic group, and an anionic group, and not including an ester bond or an amide bond (hereinafter, also referred to as simply “betaine monomer”).

A cationic group and an anionic group included in the betaine monomer acts as a hydrophilic group in the resin (A). The surface of the surface-treated treatment target may be brought into contact with a cleaning liquid including a large amount of anion having a hydrophobic group and cation having a hydrophobic group. When the resin in the surface treatment liquid has only an anionic group such as a carboxy group, a carboxylate salt group, a sulfonic acid group, and a sulfonate salt group as the hydrophilic group, these hydrophilic groups may not act as a hydrophilic group due to interaction with a cation having a hydrophobic group. Also, the resin in the surface treatment liquid includes only a cationic group such as a quaternary ammonium group as the hydrophilic group, the cationic group may not act as the hydrophilic group due to interaction with an anion included in a hydrophobic group. However, when the resin (A) includes both a cationic group and an anionic group as the hydrophilic group, if the surface of the surface-treated treatment target is brought into contact with a cleaning agent containing cations having abundant hydrophobic groups, or with a cleaning agent containing anions having abundant hydrophobic groups, either the cationic group or the anionic group can maintain the action as the hydrophilic group, so that the hydrophilic property of the surface of the treatment target is not easily deteriorated. Therefore, by forming a coating using a surface treatment liquid on a surface of the treatment target, a water contact angle of the surface of the surface-treated article can be made to be 20° C. or less, and further 15° C. or less.

The betaine monomer providing the constituent unit (a1) does not include any of an ester bond (R⁰¹-COO-R⁰²) and an amide bond (R⁰³-CONH-R⁰⁴). R⁰¹ and R⁰³ are a hydrogen atom or an organic group. R⁰² and R⁰⁴ are an organic group. When the betaine monomer includes an ester bond or an amide bond, in a resin having a constituent unit derived from such a betaine monomer, at least a part of the ester bond and the amide bond is hydrolyzed by action of acid or alkali. Therefore, when surface treatment is carried out using a surface treatment liquid including such a resin, the surface-treated article is brought into contact with a cleaning agent containing acid or alkali, a hydrophilization effect is easily deteriorated. On the other hand, in a betaine monomer that does not include an ester bond or an amide bond, hydrolysis of the ester bond or the amide bond by action of acid or alkali is suppressed, and deterioration of the hydrophilization effect is suppressed. For example, when a surface treatment liquid including a resin (A) including a constituent unit derived from a betaine monomer having a cationic group and an anionic group is used, a water contact angle on the surface of the surface-treated article to be measured after immersion of the surface-treated article in a chemical solution containing acid or alkali for 24 hours can be made to be 20° or less, and further 15° or less.

In the betaine monomer providing the constituent unit (a1), the number of cationic groups and the number of anionic groups are not particularly limited. In the betaine monomer providing the constituent unit (a1), it is preferable that the number of cationic groups and the number of anionic groups are the same as each other. Since the betaine monomer providing the constituent unit (a1) can be synthesized or obtained easily, it is preferable that the number of cationic groups and the number of anionic groups in the betaine monomer providing the constituent unit (a1) are respectively 1.

In the betaine monomer providing the constituent unit (a1), it is preferable that, for example, a group having an ethylenically unsaturated double bond, a cationic group, an anionic group are bonded in this order via a linking group as necessary.

The cationic group is preferably a cationic group being a quaternary nitrogen cation. It is preferable that the anionic group is a sulfonic acid anion group, a phosphonic acid anion group, or a carboxylic acid anion group.

Examples of the group having an ethylenically unsaturated double bond in the betaine monomer providing the constituent unit (a1) include an alkenyl group such as a vinyl group, a 1-propenyl group, a 2-n-propenyl group (allyl group), a 1-n-butenyl group, a 2-n-butenyl group, and a 3-n-butenyl group. Among these groups, a vinyl group, and a 2-n-propenyl group (allyl group) are preferable. The number of the ethylenically unsaturated double bonds in the betaine monomer providing the constituent unit (a1) is not limited, but the number is preferably 1 or 2. Since the betaine monomer providing the constituent unit (a1) does not include an ester bond or an amide bond, the betaine monomer providing the constituent unit (a1) does not include a (meth)acryloyl group as a group having an ethylenically unsaturated double bond. Note here that in this specification, the “(meth)acryl” means both “acryl” and “methacryl”.

Examples of the betaine monomer includes a monomer represented by the following formula (a1-1) or formula (a1-2):

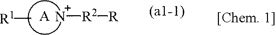

(in the formula (a1-1),
R¹ is a hydrocarbon group including an ethylenically unsaturated double bond,
R² is a divalent hydrocarbon group having 1 or more and 10 or less carbon atoms,
R is an anionic group, and
a ring A is a heterocycle), and

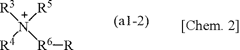

(in the formula (a1-2), R³, R⁴, and R⁵ each independently is a hydrocarbon group having an ethylenically unsaturated double bond, or a hydrocarbon group having 1 or more and 10 or less carbon atoms,
at least one of R³, R⁴, and R⁵ is a hydrocarbon group having an ethylenically unsaturated double bond,
R⁶ is a divalent hydrocarbon group having 1 or more and 10 or less carbon atoms, and
R is an anionic group).

In the formula (a1-1), the hydrocarbon group including an ethylenically unsaturated double bond as R¹ includes groups the same as the above-mentioned group having an ethylenically unsaturated double bond.

Examples of the divalent hydrocarbon group serving as R² in the formula (a1-1) include an alkylene group, an arylene group, and a group obtained by combining an alkylene group and an arylene group, and an alkylene group is preferable. Suitable specific examples of the alkylene group serving as R² include a methylene group, an ethane-1,2-diyl group, a propane-1,3-diyl group, a propane-1,2-diyl group, a butane-1,4-diyl group, a pentane-1,5-diyl group, a hexane-1,6-diyl group, a heptane-1,7-diyl group, an octane-1,8-diyl group, a nonane-1,9-diyl group, and a decane-1,10-diyl group.

In the formula (a1-1), a heterocycle as the ring A may be an aromatic heterocycle or may be an aliphatic heterocycle. Examples of the aromatic heterocycle include a ring that is a nitrogen-containing aromatic heterocycle such as an imidazole ring, a pyrazole ring, a 1,2,3-triazole ring, a 1,2,4-triazole ring, a pyridine ring, a pyrimidine ring, a pyridazine ring, and a pyrazine ring in which arbitrary one nitrogen atom in the nitrogen-containing aromatic heterocycle is made to be quaternary. Examples of the aliphatic heterocycle include a ring that is a nitrogen-containing heterocycle such as a pyrrolidine ring, a piperidine ring, and a piperazine ring in which arbitrary one nitrogen atom in the nitrogen-containing heterocycle is made to be quaternary.

In the formula (a1-2), examples of the hydrocarbon group including an ethylenically unsaturated double bond as R³ to R⁵ includes groups the same as the above-mentioned group having an ethylenically unsaturated double bond.

Examples of the hydrocarbon group serving as R³ to R⁵ in the formula (a1-2) include an alkyl group, an aryl group, an aralkyl group, and the like, and an alkyl group is preferable. The hydrocarbon group serving as R³ to R⁵ may have a substituent. The substituent which may be included in the hydrocarbon group serving as R³ to R⁵ is not particularly limited as long as the object of the present invention is not inhibited. Examples of the substituent include a halogen atom, a hydroxy group, an alkoxy group having 1 or more and 4 or less carbon atoms, an acyl group having 2 or more and 4 or less carbon atoms, an acyloxy group having 2 or more and 4 or less carbon atoms, an amino group, and an alkylamino group which is substituted with one or two alkyl groups having 1 or more and 4 or less carbon atoms. Suitable specific examples of the alkyl group serving as R³ to R⁵ include a methyl group, an ethyl group, an n-propyl group, an isopropyl group, an n-butyl group, an isobutyl group, a sec-butyl group, a tert-butyl group, an n-pentyl group, an n-hexyl group, an n-heptyl group, an n-octyl group, a 2-ethylhexyl group, an n-nonyl group, and an n-decyl group.

Examples of the divalent hydrocarbon group serving as R⁶ in the formula (a1-2) include an alkylene group, an arylene group, and a group obtained by combining an alkylene group and an arylene group, and an alkylene group is preferable. Suitable specific examples of the alkylene group serving as R⁶ include a methylene group, an ethane-1,2-diyl group, a propane-1,3-diyl group, a propane-1,2-diyl group, a butane-1,4-diyl group, a pentane-1,5-diyl group, a hexane-1,6-diyl group, a heptane-1,7-diyl group, an octane-1,8-diyl group, a nonane-1,9-diyl group, and a decane-1,10-diyl group.

As the betaine monomer in which an anionic group is a sulfonic acid anion group, due to easy synthesis and availability, monomers represented by the following formula (a1-3) or formula (a1-4) are preferable.

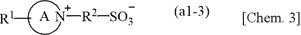

(in the formula (a1-3), R¹, R², and a ring A are the same as R¹, R², and a ring A in the formula (a1-1).)

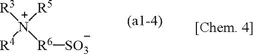

(in the formula (a1-4), R³, R⁴, R⁵, and R⁶ are the same as R³, R⁴, R⁵, and R⁶ in the formula (a1-2).)

Examples of monomers represented by the above formula (a1-3) or formula (a1-4) include monomers represented by the following formula (a1-5), (a1-6), or (a1-7).

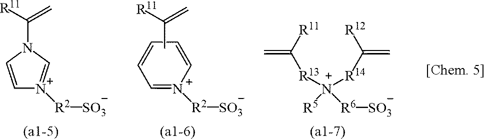

(in the formulae (a1-5), (a1-6), and (a1-7), R² is the same as R² in the formula (a1-3), R⁵ and R⁶ are the same as R⁵ and R⁶ in the formula (a1-4), R¹¹ and R¹² each independently is a hydrogen atom or a methyl group, R¹³ and R¹⁴ each independently is a single bond or an alkylene group having 1 or more and 4 or less carbon atoms.)

In the formulae (a1-5), (a1-6), and (a1-7), examples of the alkylene group having 1 or more and 4 or less carbon atoms as R¹³ and R¹⁴ include a methylene group, an ethane-1,2-diyl group, a propane-1,3-diyl group, a propane-1,2-diyl group, and a butane-1,4-diyl group.

Examples of the betaine monomer in which the anionic group is a phosphonic acid anion group or a carboxylic acid anion group include monomers represented by the above formula (a1-3) or formula (a1-4), monomers represented by the above formula (a1-5), (a1-6), or (a1-7), in which a sulfonic acid anion group (-SO₃⁻) is substituted with a phosphonic acid anion group (—(PO₃)²⁻) or a carboxylic acid anion group (-COO⁻).

Specific examples of the betaine monomer providing the constituent unit (a1) include compounds of the following formula, and monomers in which a sulfonic acid anion group (—SO₃⁻) is substituted with a phosphonic acid anion group (—(PO₃)²⁻) or a carboxylic acid anion group (-COO⁻).

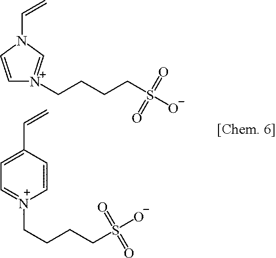

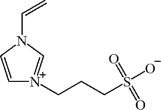

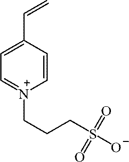

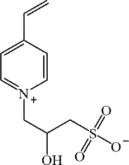 [SMILES: C=Cc1cc[n+](CC(O)CS(=O)(=O)[O-])cc1]

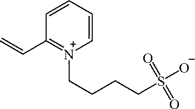 [SMILES: C=Cc1cccc[n+]1CCCCS(=O)(=O)[O-]]

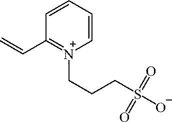

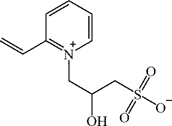 [SMILES: C=Cc1cccc[n+]1CC(O)CS(=O)(=O)[O-]]

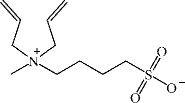 [SMILES: C=CC[N+](C)(CC=C)CCCCS(=O)(=O)[O-]]

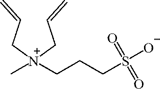

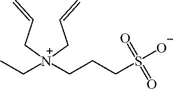 [SMILES: C=CC[N+](CC)(CC=C)CCCS(=O)(=O)[O-]]

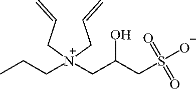 [SMILES: C=CC[N+](CC=C)(CCC)CC(O)CS(=O)(=O)[O-]]

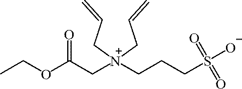 [SMILES: C=CC[N+](CC=C)(CCCS(=O)(=O)[O-])CC(=O)OCC]

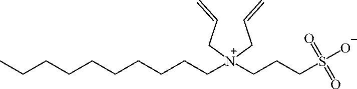 [SMILES: C=CC[N+](CC=C)(CCCCCCCCCC)CCCS(=O)(=O)[O-]]

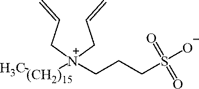

The betaine monomer providing the constituent unit (a1) can be synthesized by a well-known reaction. For example, betaine monomer can be obtained by allowing a compound having an anionic group to react with a compound including a group having an ethylenically unsaturated double bond and a group to be a cationic group. As a specific example, a compound represented by the formula (a1-3) can be obtained by allowing the below-mentioned compound to react with sultone in a solvent. Examples of sultone include sultone having 4-membered ring or more and 10-membered ring or less, and preferable examples thereof include 1,3-propanesultone and 1,4-butanesulton.

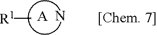

(in the formula, R¹ is the same as R¹ in the above (a1-1), the ring A is a heterocycle.)

The resin (A) may include one type or two types or more of the constituent units (a1).

A percentage of the constituent unit (a1) with respect to all of the constituent units of the resin (A) is not particularly limited as long as the object of the present invention is not inhibited. For example, the percentage of the constituent unit (a1) with respect to all of the constituent units of the resin (A) is preferably 70 mol% or more. The percentage of the constituent unit (a1) with respect to all of the constituent units of the resin (A) may be 80 mol% or more, may be 85 mol% or more, may be 90 mol% or more, may be 94 mol% or more, or may be 100 mol%. Although the percentage of the constituent unit (a1) described above is not particularly limited, examples thereof include 100 mol% or less.

### (Constituent Unit (a2))

The resin (A) may include the constituent unit (a1) described above and a constituent unit (a2) being a constituent unit other than the constituent unit (a1). The constituent unit (a2) may include or may not include a hydrophilic group. The constituent unit (a2) having the hydrophilic group is a constituent unit derived from a monomer other than the above-described betaine monomer, and including a hydrophilic group and an ethylenically unsaturated double bond.

The hydrophilic group described above is not particularly limited as long as it is generally recognized as a hydrophilic group by a person skilled in the art. Specific examples of the hydrophilic group include a primary amino group, a secondary amino group, a carboxy group, a phenolic hydroxy group, a sulfonic acid group, polyoxyalkylene groups (for example, a polyoxyethylene group, a polyoxypropylene group, and a polyoxyalkylene group in which an oxyethylene group and an oxypropylene group are block-bonded or randomly bonded), an alcoholic hydroxy group, and the like.

A percentage of the constituent unit (a2) with respect to all of the constituent units of the resin (A) is not particularly limited as long as a desired surface treatment effect is obtained. For example, when the constituent unit (a2) is included, the percentage of the constituent unit (a2) with respect to all of the constituent units of the resin (A) is preferably 0.01 mol% or more and 30 mol% or less, and more preferably 0.1 mol% or more and 15 mol% or less.

From the viewpoint of chemical resistance, it is preferable that the constituent unit (a2) does not include an ester bond and an amide bond. When the constituent unit (a2) includes an ester bond or an amide bond, the percentage of the constituent unit (a2) having an ester bond or an amide bond with respect to all constituent units constituting the resin (A) is 10 mol% or less, and more preferably 6 mol% or less.

### (Adhesive Group)

A resin (A) preferably includes an adhesive group in order to improve adhesion property between a surface of a treatment target and a resin (A). The adhesive group is not particularly limited as long as it enhances the adhesion property of the resin (A) to a surface of a treatment target. Preferable examples of the adhesive group include -SiR⁷ₐR⁸_{3-a,} —NH₂, and —PO₃H. In the formula SiR⁷ₐR⁸₃₋ₐ, R⁷ is a hydroxy group, an alkoxy group having 1 or more and 4 or less carbon atoms, or a halogen atom, R⁸ is an optionally substituted hydrocarbon group having 1 or more and 10 or less carbon atoms, and a is an integer from 1 to 3. When the resin (A) includes adhesive groups such as -SiR⁷ₐR⁸₃₋ₐ, —NH₂ or —PO₃H, deterioration of hydrophilic property due to friction of a surface of an article treated with a surface treatment agent is easily suppressed. A bonding position of the adhesive group in the resin (A) is not particularly limited. Preferably, the adhesive group is bonded to a molecular chain terminal of the resin (A).

-SiR⁷ₐR⁸₃₋ₐ is a reactive silyl group, and includes a silanol group (a hydroxy group), or a group generating a silanol group by hydrolysis (an alkoxy group, and a halogen atom). Therefore, when the surface treatment is carried out using a surface treatment liquid including the resin (A) having -SiR⁷ₐR⁸₃₋ₐ, -SiR⁷ₐR⁸₃₋ₐ reacts with the surface of the treatment target. Therefore, the resin (A) is firmly bonded to the surface of the treatment target, deterioration of the hydrophilic property of the surface of the surface-treated treatment target due to friction is suppressed. In terms of the reactivity of the reactive silyl group with the surface of the treatment target, a is preferably 2 or 3, and more preferably 3. Furthermore, when a is 2 or 3, a condensation reaction occurs between one -SiR⁷ₐR⁸₃₋ₐ and its adjacent -SiR⁷ₐR⁸₃₋ₐ on the surface of the treatment target. As a result, in the coating, a network of siloxane bonds which is extended along the surface of the treatment target is formed, and thus the resin (A) is easily bonded to the surface of the treatment target particularly firmly.

When the resin (A) includes —NH₂ and —PO₃H as the adhesive groups, the interaction such as a hydrogen bond between the surface of the treatment target and these adhesive groups, the resin (A) is considered to be firmly bonded to the surface of the treatment target.

Examples of the halogen atom serving as R⁷ in -SiR⁷ₐR⁸₃₋ₐ include a chlorine atom, a bromine atom, an iodine atom, and the like, and a chlorine atom is preferable. Suitable examples of the alkoxy group serving as R⁷ include a methoxy group, an ethoxy group, an n-propyloxy group, an isopropyloxy group, and an n-butyloxy group, and a methoxy group and an ethoxy group are more preferable.

As the hydrocarbon group serving as R⁸ in -SiR⁷ₐR⁸₃₋ₐ, an alkyl group, an aralkyl group or an aryl group is preferable. When R⁸ is an alkyl group, the number of carbon atoms thereof is preferably 1 or more and 6 or less, more preferably 1 or more and 4 or less, and preferably 1 or 2. Suitable examples of the alkyl group when R⁸ is an alkyl group include a methyl group, an ethyl group, an n-propyl group, an isopropyl group, and an n-butyl group, and a methyl group and an ethyl group are more preferable. As the aralkyl group, a benzyl group and a phenethyl group are preferable. As the aryl group, a phenyl group, a naphthalen-1-yl group, and a naphthalen-2-yl group are preferable, and a phenyl group is more preferable.

As suitable examples of -SiR⁷ₐR⁸₃₋ₐ, a trimethoxysilyl group, a triethoxysilyl group, a tri-n-propyloxysilyl group, a methyldimethoxysilyl group, an ethyldimethoxysilyl group, a methyldiethoxysyl group, and an ethyldiethoxysilyl group are preferable, and a trimethoxysilyl group and a triethoxysilyl group are more preferable.

In terms of ease of introduction into the resin (A), -SiR⁷ₐR⁸₃₋ₐ is preferably introduced into the resin (A) as a group represented by the following formula (1).

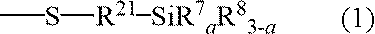

(in the formula (1), R²¹ is a divalent hydrocarbon group having 1 or more and 20 or less carbon atoms, R⁷, R⁸, and a are the same as R⁷, R⁸, and a in -SiR⁷ₐR⁸₃₋ₐ, respectively.)

In the formula (1) described above, the number of carbon atoms in the divalent hydrocarbon group serving as R²¹ is preferably 1 or more and 10 or less, more preferably 1 or more and 6 or less, and particularly preferably 2 or more and 4 or less. Examples of the divalent hydrocarbon group serving as R²¹ include an alkylene group, an arylene group, and a group obtained by combining an alkylene group and an arylene group, and an alkylene group is preferable. Suitable specific examples of the alkylene group serving as R²¹ include a methylene group, an ethane-1,2-diyl group, a propane-1,3-diyl group, a propane-1,2-diyl group, a butane-1,4-diyl group, a pentane-1,5-diyl group, a hexane-1,6-diyl group, a heptane-1,7-diyl group, an octane-1,8-diyl group, a nonane-1,9-diyl group, and a decane-1,10-diyl group.

The amount of -SiR⁷ₐR⁸₃₋ₐ, —NH₂ and —PO₃H in the resin (A) is not particularly limited as long as the object of the present invention is not inhibited. In terms of reactivity of the resin (A) with the surface of the treatment target, the total amount of -SiR⁷ₐR⁸₃₋ₐ, —NH₂, and —PO₃H in the resin (A) with respect to all of the constituent units of the resin (A) is preferably 0.01 mol% or more and 20 mol% or less, more preferably 0.1 mol% or more and 10 mol% or less, and further preferably 0.1 mol% or more and 5 mol% or less.

### (Synthesis Method of Resin (A))

The resin (A) can be prepared by polymerizing the betaine monomer providing the constituent unit (a1), and a monomer providing the constituent unit (a2) as necessary by a well-known method. Examples of preferable methods include a method of subjecting a monomer providing the constituent unit constituting the resin (A) to radical polymerization in the presence of the polymerization initiating agent. As the polymerization initiating agent, for example, an azo polymerization initiating agent is mentioned. Examples of the polymerization initiating agent described above include 2,2′-azobis (2-methylpropionamidine) dihydrochloride (dihydrochloride), 2,2′-azobis [2-(phenylamidino) propane] dihydrochloride, 2,2′-azobis {2-[N-(4-chlorophenyl)amidino]propane}dihydrochloride, 2,2′-azobis {2-[N-(4-hydroxyphenyl)amidino]propane}dihydrochloride, 2,2′-azobis[2-(N-benzylamidino) propane]dihydrochloride, 2,2′-azobis[2-(N-allylamidino)propane] dihydrochloride, 2,2′-azobis (2-amidinopropane)dihydrochloride, 2,2′-azobis{2-[N-(4-hydroxyethyl) amidino] propane}dihydrochloride, 2,2-azobis[2-(5-methyl-2-imidazolin-2-yl)propane] dihydrochloride, 2,2-azobis [2-(2-imidazolin-2-yl)propane]dihydrochloride, 2,2-azobis [2-(4,5,6,7-tetrahydro-1H-1,3-diazepin-2-yl)propane] dihydrochloride, 2,2-azobis [2-(3,4,5,6-tetrahydropyrimidin-2-yl)propane]dihydrochloride, 2,2-azobis[2-(5-hydroxy-3,4,5,6-tetrahydropyrimidin-2-yl)propane]dihydrochloride, 2,2-azobis{2-[1-(2-hydroxyethyl)-2-imidazolin-2-yl]propane} dihydrochloride and 2,2-azobis[2-(2-imidazoline-2-yl)propane]. These polymerization initiating agents may be used singly, or two or more types thereof may be combined so as to be used. The amount of the polymerization initiating agent used is not particularly limited as long as the polymerization reaction can be favorably carried out. The amount of the polymerization initiating agent used is preferably 0.1 mol% or more and 20 mol% or less, and more preferably 0.1 mol% or more and 15 mol% or less with respect to the number of moles of the entire monomer.

When the resin (A) includes -SiR⁷ₐR⁸₃₋ₐ, —NH₂ or —PO₃H, in the polymerization of the betaine monomer providing the constituent unit (a1), and a monomer providing the constituent unit (a2) as necessary, preparation can be carried out using a monomer providing -SiR⁷ₐR⁸₃₋ₐ, —NH₂ or —PO₃H. Furthermore, after the betaine monomer providing the constituent unit (a1) and a monomer providing the constituent unit (a2) as necessary are polymerized, at the terminal of the obtained polymer, preparation can be carried out by introducing -SiR⁷ₐR⁸₃₋ₐ, -NH₂ or —PO₃H according to a known method. For example, by producing a so-called thiol-ene reaction between a terminal vinyl group of a precursor of resin (A) essentially including the above-mentioned constituent unit (a1) and including a constituent unit (a2) as necessary, and a compound having a mercapto group such as compound represented by the following formula (2), a terminal group derived from the compound represented by the following formula (2) can be introduced into the resin (A).

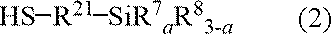

(in the formula (2), R⁷, R⁸, R²¹, and a are the same as R⁷, R⁸, R²¹, and a in the formula (1), respectively.)

A percentage of the mass of the resin (A) with respect to the mass of the surface treatment liquid is not particularly limited, but it is preferably 0.1 mass% or more and 5 mass% or less, more preferably 0.1 mass% or more and 3.0 mass% or less, and further preferably 0.1 mass% or more and 1.5 mass% or less.

### <Electrolyte (B)>

The surface treatment liquid may contain an electrolyte (B). When the surface treatment liquid includes the electrolyte (B), the resin (A) is easily dissolved in the surface treatment liquid uniformly and stably. The electrolyte (B) is a substance other than the resin (A). The resin (A) capable of being ionized in the surface treatment liquid is defined not as the electrolyte (B) but as the resin (A).

The type of electrolyte (B) is not particularly limited as long as the electrolyte (B) is not a substance which decomposes the resin (A). The type of electrolyte (B) is not particularly limited. The electrolyte (B) may be either a substance which is generally regarded as a strong electrolyte such as hydrochloric acid, sodium chloride or potassium chloride, or a substance which is generally regarded as a weak electrolyte such as an anionic surfactant (for example, sodium dodecyl sulfate) or a cationic surfactant (for example, benzalkonium chloride).

In terms of, for example, ease of availability and low cost, suitable examples of the electrolyte (B) include sodium chloride, potassium chloride, sodium perchlorate, potassium perchlorate, sodium hydroxide, potassium hydroxide, perchloric acid, hydrochloric acid, sulfuric acid, and the like.

The content of the electrolyte (B) is not particularly limited as long as the object of the present invention is not inhibited and it is determined as necessary with consideration given to solubility in the surface treatment liquid and the like. For example, the content of the electrolyte (B) is preferably 0 parts by mass or more and 700 parts by mass or less, more preferably 0 parts by mass or more and 600 parts by mass or less, and further preferably 0 parts by mass or more and 500 parts by mass or less with respect to 100 parts by mass of the resin (A).

### [Solvent (S)]

The surface treatment liquid contains the solvent (S). The solvent (S) may be water, an organic solvent, or an aqueous solution of an organic solvent. As the solvent (S), water is preferable in terms of the solubility of the resin (A), the safety of the operation of the hydrophilization treatment and low cost, and the like. As a suitable example of the organic solvent used as the solvent (S), alcohol is mentioned. As the alcohol, an aliphatic alcohol is mentioned, and alcohol having 1 or more and 3 or less carbon atoms is preferable. Specific examples thereof include methanol, ethanol, n-propyl alcohol, and isopropyl alcohol (IPA), and methanol, ethanol, and isopropyl alcohol are preferable. One type or a combination of two or more types of alcohols described above may be used.

The content of water in the solvent (S) is preferably 50 mass% or more, more preferably 80 mass% or more and particularly preferably 100 mass%.

### [Other Components]

The surface treatment liquid may contain various additive agents as long as the object of the present invention is not inhibited. Examples of the additive agent described above include a thermal polymerization inhibiting agent, a photopolymerization inhibiting agent, an anti-oxidizing agent, an ultraviolet light absorbing agent, a coloring agent, an antifoaming agent, a viscosity adjustment agent, and the like. The contents of these additive agents are determined as appropriate with consideration given to the normally used amounts of these additive agents.

### Hydrophilization Treatment Method

A hydrophilization treatment method is not particularly limited as long as the method can allow a resin (A) to be bonded or adhere to a surface of the treatment target such that a surface of the treatment target is hydrophilized to a desired level. Typically, the hydrophilization treatment method includes forming a coating on the surface of the treatment target by applying the surface treatment liquid described above. However, it is not necessary to form a uniform coating on the entire surface of the surface of the treatment target to be hydrophilized as long as the surface of the treatment target is hydrophilized to a desired level. Preferably, the hydrophilization treatment method further includes rinsing the surface of the treatment target with a rinse liquid after the application of the surface treatment liquid.

Hereinafter, the application of the surface treatment liquid to the surface of the treatment target so as to form the coating is also referred to as an “applying step”. Rinsing of the surface of the treatment target with the rinse liquid after the application of the surface treatment liquid is also referred to as a “rinsing step”. Hereinafter, the applying step, the rinsing step and the surface treatment liquid will be described in detail.

### <Applying Step>

In the applying step, the surface treatment liquid described above is applied to the surface of the treatment target so as to form a coating. An applying method is not particularly limited. Specific examples of the applying method include a spin coat method, a spray method, a roller coat method, an immersion method, and the like. When the treatment target is a substrate, since the coating having a uniform film thickness is evenly and easily formed on the surface of the substrate, the spin coat method is preferable as the applying method.

The material of the surface of the treatment target to which the surface treatment liquid is applied is not particularly limited and may be either an organic material or an inorganic material. Examples of the organic material include various resin materials such as polyester resins such as a PET resin and a PBT resin, various types of nylons, a polyimide resin, a polyamide-imide resin, polyolefins such as polyethylene and polypropylene, polystyrene, a (meth) acrylic resin, a cycloolefin polymer (COP), a cycloolefin copolymer (COC), and a silicone resin (for example, polyorganosiloxanes such as polydimethylsiloxane (PDMS). Photosensitive resin components contained in various resist materials and alkalisoluble resin components are also preferred as the organic material. Examples of the inorganic material include glass, silicon, and various metals such as copper, aluminum, iron and tungsten. The metals may be alloys.

The shape of the treatment target is not particularly limited. The treatment target may be a flat shape, or a three-dimensional shape, for example, a spherical shape or a columnar shape.

The treatment target may be exposed to chemicals such as cleaning agents, and there is a concern that the hydrophilicity of the coating formed on the treatment target may be deteriorated due to exposure to chemicals. However, with the use of the above-described surface treatment liquid, it is possible to suppress the deterioration of hydrophilicity when the surface-treated surface comes into contact with various chemicals. Therefore, by using glass members or transparent resin members provided in a treatment target, for example, a window, a mirror, furniture, and optical devices (for example, devices each having a lens), which are often exposed to chemicals such as a cleaning liquid, as the treatment target, the effect of chemical resistance with respect to hydrophilicity can be particularly exhibited.

After applying the surface treatment liquid to the surface of the treatment target, by a known drying method, as necessary, at least part of the solvent (S) may be removed from the coating formed of the surface treatment liquid.

The film thickness of the coating formed in the applying step is not particularly limited. For example, the film thickness of the coating formed in the applying step is preferably 1 µm or less, more preferably 300 nm or less, and further preferably 100 nm or less.

The thickness of the coating formed in the applying step can be adjusted by adjusting the concentration of the solid content of the surface treatment liquid, the applying conditions, and the like.

### <Rinsing Step>

In the rinsing step, after the application of the surface treatment liquid, the surface of the treatment target is rinsed with the rinse liquid. By rinsing, it is possible to reduce the thickness of the coating formed on the surface of the treatment target. The rinse liquid is not particularly limited as long as the coating having a desired film thickness can be formed. As the rinse liquid, water, an organic solvent, and an aqueous solution of an organic solvent can be used. As the rinse liquid, water is preferable. A method of rinsing the coating is not particularly limited. Typically, the rinse liquid is brought into contact with the coating by the same method as the applying method described above to perform rinsing.

Before rinsing is performed, part or the whole of the solvent (S) contained in the coating may be removed by heating of the coating. A heating temperature is not particularly limited as long as the treatment target and the resin (A) are prevented from being deteriorated or degraded or decomposed. A typical heating temperature is a temperature of about 50° C. or more and 300° C. or less. A heating time is not particularly limited, and the heating time is, for example, 5 seconds or more and 24 hours or less, and preferably 10 seconds or more and 6 hours or less.

For example, the film thickness of the coating obtained after rinsing is preferably 10 nm or less, more preferably 0.1 nm or more and 10 nm or less, further preferably 0.1 nm or more and 8 nm or less, yet more preferably 0.5 nm or more and 5 nm or less, and particularly preferably 0.5 nm or more and 3 nm or less.

The thickness of the coating can be adjusted by adjusting the concentration of the solid content of the surface treatment liquid, the applying conditions, the amount of rinse liquid used, the type of rinse liquid, the temperature of the rinse liquid, and the like.

After rinsing, the treatment target is dried as necessary, and thereafter the treatment target is suitably used for various applications.

### EXAMPLES

Although the present invention will be more specifically described below using Examples, the scope of the present invention is not limited to these Examples.

### [Preparation Example 1] Preparation of Betaine Monomer BM1

By allowing 1-vinylimidazole and 1,4-butanesulton to react with each other in acetonitrile, a betaine monomer BM1 was obtained.

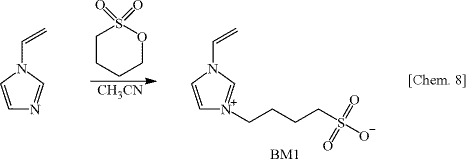

### [Preparation Example 2] Preparation of Betaine Monomer BM2

By allowing 4-vinylpyridine and 1,4-butanesulton to react with each other in acetonitrile, a betaine monomer BM2 was obtained.

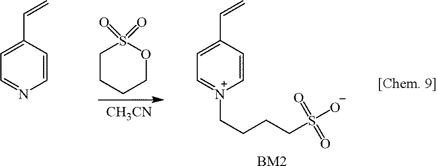

### [Preparation Example 3] Preparation of Betaine Monomer BM3

By allowing diallylmethylamine and 1,3-propanesultone to react with each other in acetonitrile, a betaine monomer BM3 was obtained.

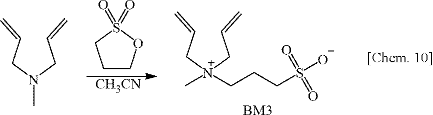

### [Preparation Example 4] Preparation of Betaine Monomer BM4

By allowing 2-vinylpyridine and 1,4-butanesulton to react with each other in acetonitrile, a betaine monomer BM4 was obtained.

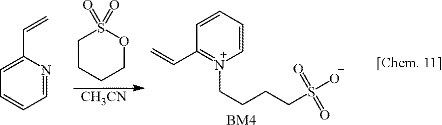

### [Preparation Examples 4 to 15] Preparation of Resins A1 to A11

Monomers and polymerization initiating agents of types and amounts (mmol) described in Tables 1 and 2 were made into an aqueous solution having a monomer concentration of 30 mass%, and radical polymerization was then performed at 80° C. for 6 hours, and thus resin liquids 1 to 13 described in table 1 were obtained as aqueous solutions or suspensions of resins. Raw materials for resin synthesis described in Tables 1 and 2 are BM1 to BM4 mentioned above, and C1 to C2, AD1 to AD4 and Init 1 mentioned below.
AD1: 3-(methacryloyloxy)propyltrimethoxysilane
AD2: 3-(trimethoxysilyl)propanethiol
AD3: 3-amino-5-mercapto-1,2,4-triazole
AD4: 4,6-diamino-2-mercaptopyrimidine
C1: Acrylic acid
C2: N-[2-(dimethylamino)ethyl]acrylamide
Init 1: 2,2′-azobis(2-methylpropionamidine)dihydrochloride

TABLE 1

| | | Resin liquid 1 | Resin liquid 2 | Resin liquid 3 | Resin liquid 4 | Resin liquid 5 | Resin liquid 6 |
|---|---|---|---|---|---|---|---|
| Monomer (mmol) | BM1 | 21.71 | - | - | 21.71 | 21.71 | - |
| | BM2 | - | 20.72 | - | - | - | - |
| | BM3 | - | - | 20.21 | - | - | 20.21 |
| | AD1 | 1.14 | 1.06 | 1.09 | - | - | - |
| | AD2 | - | - | - | 1.14 | - | - |
| | AD3 | - | - | - | - | 1.14 | - |
| | AD4 | - | - | - | - | - | 1.06 |
| Polymerization initiating agent (mmol) | Init 1 | 1.15 | 1. 06 | 1.09 | 1.14 | 1.14 | 1.06 |

TABLE 2

| | | Resin liquid 7 | Resin liquid 8 | Resin liquid 9 | Resin liquid 10 | Resin liquid 11 | Resin liquid 12 | Resin liquid 13 |
|---|---|---|---|---|---|---|---|---|
| Monomer (mmol) | BM1 | 21.71 | - | - | - | - | - | - |
| | BM2 | - | 20.72 | - | - | 10.11 | - | - |
| | BM3 | - | - | 20.21 | - | 10.11 | - | - |
| | BM4 | - | - | - | 20.72 | - | - | - |
| | AD1 | - | - | - | 1.06 | - | 0.91 | 1.85 |
| | AD2 | - | - | - | - | 0.41 | - | - |
| | C1 | - | - | - | - | - | 69.39 | - |
| | C2 | - | - | - | - | - | - | 35.10 |
| Polymerization initiating agent (mmol) | Init 1 | 1.09 | 1.04 | 1.01 | 1.06 | 1.03 | 3.65 | 1.85 |

### Examples 1 to 11 and Comparative Examples 1 to 3

A surface treatment liquid was obtained by using a resin liquid and an electrolyte of types described in Tables 3 and 4 and water so that the resin and the electrolyte had the concentrations described in Tables 3 and 4. Note here that in Comparative Example 6, the resin P1 mentioned below was used as the resin liquid. Furthermore, electrolytes described in Tables 3 and 4 as follows.
P1: poly(diallyldimethylammonium chloride) (manufactured by Sigma-Aldrich Co. LLC, mass average molecular weight Mw: 400000 to 500000)
B1: Sodium chloride

The obtained surface treatment liquids of Examples 1 to 11, Comparative Examples 1 to 3 were subjected to evaluations of hydrophilization treatment according to the methods of evaluations 1 to 6 below. The results of these evaluations are shown in tables 3 and 4.

### <Evaluation 1> Water Contact Angle at Initial Stage

As a treatment target, a silicon wafer was used. The silicon wafer was immersed in the surface treatment liquid at room temperature for one minute. The silicon wafer was lifted up from the surface treatment liquid and was thereafter subjected to heating treatment at 180° C. for 5 minutes. The silicon wafer was cooled to room temperature and was thereafter rinsed with pure water. The silicon wafer after being rinsed was dried, and thereafter the film thickness of a coating formed on the surface of the silicon wafer was measured by spectroscopic ellipsometry. As a result, in Examples 1 to 11 and Comparative Examples 1 to 3, a coating has a thickness of 2 nm. In the coating formed on the silicon wafer, the water contact angle was evaluated by the following methods.

### <Contact Angle Evaluation>

The water contact angle was measured using Dropmaster 700 (manufactured by Kyowa Interface Science Co., Ltd.) as follows: a pure water droplet (2.0 µL) was dropped onto a surface-treated surface of a silicon wafer substrate, and the contact angle was measured after 10 seconds of dropping as the contact angle of water. An average value of the water contact angles on three points on the silicon wafer are shown in Tables 3 and 4.

### <Evaluation 2> Alkali Resistance Test

In the same manner as in evaluation 1, the surface treatment of the silicon wafer was performed with the surface treatment liquid. Then, the surface-treated silicon wafer was immersed in a sodium hydroxide aqueous solution of pH12 at room temperature for 24 hours. The surface of the silicon wafer lifted up from the sodium hydroxide aqueous solution was subjected to air blowing, thus the sodium hydroxide aqueous solution was removed from the surface of the silicon wafer. Then, the silicon wafer was washed with water, and the evaluation of the contact angle of water was performed in the same manner as in evaluation 1.

### <Evaluation 3> Acid Resistance Test

In the same manner as in evaluation 1, the surface treatment of the silicon wafer was performed with the surface treatment liquid. Then, the surface-treated silicon wafer was immersed in a sulfuric acid aqueous solution of pH1 at room temperature for 24 hours. The surface of the silicon wafer lifted up from the sulfuric acid aqueous solution was subjected to air blowing, thus sulfuric acid was removed from the surface of the silicon wafer, and the silicon wafer was then washed with water. Then, the evaluation of the contact angle of water was performed in the same manner as in evaluation 1.

### <Evaluation 4> SDS (Sodium Dodecyl Sulfate) Resistance Test

In the same manner as in evaluation 1, the surface treatment of the silicon wafer was performed with the surface treatment liquid. Then, surface-treated silicon wafer was immersed in SDS aqueous solution having a concentration of 1% by mass at room temperature for 24 hours. The surface of the silicon wafer lifted up from the SDS aqueous solution was subjected to air blowing, thus the SDS aqueous solution was removed from the surface of the silicon wafer, and the silicon wafer was then washed with water. Then, the evaluation of the contact angle of water was performed in the same manner as in evaluation 1.

### <Evaluation 5> Tri-n-pentylamine Resistance Test

In the same manner as in evaluation 1, the surface treatment of the silicon wafer was performed with the surface treatment liquid. Then, surface-treated silicon wafer was immersed in a tri-n-pentylamine aqueous solution having a concentration of 0.5% by mass at room temperature for 24 hours. The surface of the silicon wafer lifted up from the tri-n-pentylamine aqueous solution was subjected to air blowing, thus the tri-n-pentylamine aqueous solution was removed from the surface of the silicon wafer, and the silicon wafer was then washed with water, and the evaluation of the contact angle of water was performed in the same manner as in evaluation 1.

### <Evaluation 6> Rubbing Resistance Test

Silicon wafer was subjected to surface treatment with the surface treatment liquid in the same manner as in Evaluation 1. The surface-treated silicon wafer was then subjected to 10 reciprocal rubbing tests at a load of 2 kg using 2 cm square Scotch-Bright antibacterial urethane (manufactured by 3 M Company). For the silicon wafer after the rubbing test, the contact angle of water was evaluated in the same manner as in Evaluation 1.

TABLE 3

| | | Example 1 | Example 2 | Example 3 | Example 4 | Example 5 | Example 6 |
|---|---|---|---|---|---|---|---|
| Surface treatment liquid | Resin Liquid | Resin liquid 1 | Resin liquid 2 | Resin liquid 3 | Resin liquid 4 | Resin liquid 5 | Resin liquid 6 |
| | Resin concentration (mass%) | 1 | 1 | 1 | 1 | 1 | 1 |
| | Types of electrolyte | B1 | B1 | B1 | B1 | B1 | B1 |
| | Electrolyte concentration (mass%) | 4 | 4 | 4 | 4 | 4 | 4 |
| Evaluation (Contact angle of water) | Initial stage | 12° | 12° | 8° | 12° | 13° | 8° |
| | Alkali resistance test | 14° | 14° | 10° | 14° | 14° | 14° |
| | Acid resistance test | 15° | 12° | 15° | 14° | 15° | 12° |
| | SDS resistance test | 12° | 12° | 10° | 12° | 12° | 10° |
| | Tri-n-pentylamine resistance test | 12° | 12° | 10° | 10° | 12° | 10° |
| | Rubbing resistance test | 15° | 14° | 10° | 11° | 12° | 10° |

TABLE 4

| | | Example 7 | Example 8 | Example 9 | Example 10 | Example 11 | Comparative Example 1 | Comparative Example 2 | Comparative Example 3 |
|---|---|---|---|---|---|---|---|---|---|
| Surface treatment liquid | Resin liquid | Resin liquid 7 | Resin liquid 8 | Resin liquid 9 | Resin liquid 10 | Resin liquid 11 | Resin liquid 12 | Resin liquid 13 | Resin P1 |
| | Resin concentration (mass%) | 1 | 1 | 1 | 1 | 1 | 1 | 1 | 1 |
| | Types of electrolyte | B1 | B1 | B1 | B1 | B1 | — | — | — |
| | Electrolyte concentration (mass%) | 4 | 4 | 4 | 4 | 4 | — | — | — |
| Evaluation (Contact angle of water) | Initial stage | 12° | 10° | 9° | 12° | 13° | 35° | 30° | 8° |
| | Alkali resistance test | 15° | 15° | 14° | 10° | 13° | 36° | 57° | 10° |
| | Acid resistance test | 15° | 15° | 14° | 12° | 13° | 38° | 54° | 12° |
| | SDS resistance test | 10° | 12° | 10° | 12° | 15° | 38° | 70° | 72° |
| | Tri-n-pentylamine resistance test | 14° | 12° | 10° | 11° | 12° | 65° | 35° | 14° |
| | Rubbing resistance test | 45° | 50° | 50° | 13° | 15° | 38° | 32° | 53° |

According to Examples 1 to 11, it is shown that when a surface treatment liquid including a resin (A) and a solvent (S), the resin (A) including a constituent unit (a1) derived from a betaine monomer including a group having an ethylenically unsaturated double bond, a cationic group, and an anionic group, and not including an ester bond or an amide bond is used, the hydrophilic property is not easily deteriorated even if the surface is brought into contact with various chemicals. It is shown that with the surface treatment liquid of Examples 1 to 6, 10 and 11, when the resin (A) includes adhesive groups such as -SiR⁷ₐR⁸₃₋ₐ or —NH₂, even if the surface-treated surface of the treatment target is subjected to friction, a hydrophilization effect is not inhibited.

On the other hand, according to the surface treatment liquid of Comparative Examples 1 to 3, when the resin (A) does not include a constituent unit (a1) derived from a betaine monomer including a group having an ethylenically unsaturated double bond, a cationic group, and an anionic group, and not including an ester bond or an amide bond, it is shown that any of chemical resistance is bad. Furthermore, in Comparative Example 1 and Comparative Example 2, initial contact angle is high and desired a hydrophilization effect cannot be easily obtained.

1. A surface treatment liquid comprising a resin (A) and a solvent (S),
the resin (A) comprising a constituent unit (a1) derived from a betaine monomer comprising a group having an ethylenically unsaturated double bond, a cationic group, and an anionic group, and not comprising an ester bond or an amide bond.

2. The surface treatment liquid according to claim 1, wherein the cationic group is a quaternary nitrogen cation group.

3. The surface treatment liquid according to claim 1, wherein the anionic group is a sulfonic acid anion group, a phosphonic acid anion group, or a carboxylic acid anion group.

4. The surface treatment liquid according to claim 1, wherein the betaine monomer is a monomer represented by the following formula (a1-1) or formula (a1-2): 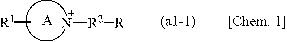
wherein in the formula (a1-1),
R¹ is a hydrocarbon group comprising an ethylenically unsaturated double bond,
R² is a divalent hydrocarbon group having 1 or more and 10 or less carbon atoms,
R is an anionic group, and
a ring A is a heterocycle; and 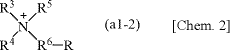
wherein in the formula (a1-2),
R³, R⁴, and R⁵ each independently is a hydrocarbon group having an ethylenically unsaturated double bond, or a hydrocarbon group having 1 or more and 10 or less carbon atoms,
at least one of R³, R⁴, and R⁵ is a hydrocarbon group having an ethylenically unsaturated double bond,
R⁶ is a divalent hydrocarbon group having 1 or more and 10 or less carbon atoms, and
R is an anionic group.

5. The surface treatment liquid according to claim 4, wherein the betaine monomer is a monomer represented by the following formula (a1-3) or formula (a1-4): 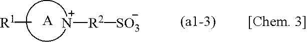
wherein in the formula (a1-3), R¹, R², and a ring A are the same as R², and the ring A in the formula (a1-1); and 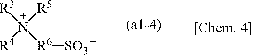
wherein in the formula (a1-4), R³, R⁴, R⁵, and R⁶ are the same as R³, R⁴, R⁵, and R⁶ in the formula (a1-2).

6. The surface treatment liquid according to claim 1, wherein the resin (A) includes -SiR⁷ₐR⁸₃₋ₐ, —NH₂, or —PO₃H,
wherein in the formula -SiR⁷ₐR⁸₃₋ₐ, R⁷ is a hydroxy group, an alkoxy group having 1 or more and 4 or less carbon atoms, or a halogen atom, R⁸ is an optionally substituted hydrocarbon group having 1 or more and 10 or less carbon atoms, and a is an integer from 1 to 3.

7. The surface treatment liquid according to claim 1, wherein a percentage of the constituent unit (a1) with respect to all of the constituent units constituting the resin (A) is 70 mol% or more.

8. The surface treatment liquid according to claim 1, further comprising an electrolyte (B).

9. The surface treatment liquid according to claim 8, wherein the electrolyte (B) comprises at least one selected from sodium chloride, potassium chloride, sodium perchlorate, potassium perchlorate, sodium hydroxide, potassium hydroxide, perchloric acid, sulfuric acid, and hydrochloric acid.

10. The surface treatment liquid according to claim 1, wherein the solvent (S) comprises water.

11. A hydrophilization treatment method for making a surface of a treatment target hydrophilic, the method comprising applying the surface treatment liquid according to claim 1 to form a coating on the surface of the treatment target.

12. The hydrophilization treatment method according to claim 11, further comprising: rinsing the surface of the treatment target with a rinse liquid after application of the surface treatment liquid.

13. The hydrophilization treatment method according to claim 11, wherein the treatment target is a glass member or a transparent resin member provided in a window, a mirror, furniture, or optical devices.
